(19) United States
(12) Patent Application Publication
(10) Pub. No.: US 2017/0270516 A1
(43) Pub. Date: Sep. 21, 2017

(54) SYSTEMS AND METHODS FOR CUSTOMIZED FINGERPRINT AUTHENTICATION

(71) Applicant: eBay Inc., San Jose, CA (US)

(72) Inventors: In Seok Jeong, San Jose, CA (US); Jun Ho Cho, Seoul (KR)

(21) Appl. No.: 15/073,930

(22) Filed: Mar. 18, 2016

(51) Int. Cl. G06Q 20/36; H04L 29/06

(52) U.S. Cl. CPC G06Q 20/3674; H04L 63/0861

(57) ABSTRACT

Systems and methods are presented for receiving, at a server computer, a request to register a first fingerprint data, the request including the first fingerprint data and an action to be associated with the first fingerprint data, storing, by the server computer, the first fingerprint data and the action associated with the first fingerprint data, receiving, by the server computer, a request for authentication of a second fingerprint data, analyzing, by the server computer, the second fingerprint data to determine whether it matches stored fingerprint data, determining, by the server computer, that the second fingerprint data matches the stored first fingerprint data, determining, by the server computer, the action associated with the first fingerprint data, and sending, by the server computer, a response indicating that the second fingerprint data matches the stored fingerprint data and including the action associated with the first fingerprint data.

### TECHNICAL FIELD

The present disclosure relates generally to a mechanism for customized fingerprint authentication.

### BACKGROUND

Due to security precautions, a user has to go through multiple stages of authentication when logging onto a system or when conducting a payment transaction through a computing device (e.g., a mobile device). Moreover, customizing security and payment methods to each individual user is a problem.

### BRIEF DESCRIPTION OF THE DRAWINGS

Various ones of the appended drawings merely illustrate example embodiments of the present disclosure and should not be considered as limiting its scope.

FIG. 1 is a block diagram illustrating a networked system for customized fingerprint authentication, according to some example embodiments.

FIG. 2 is a flowchart illustrating aspects of a method for registering fingerprint data, according to some example embodiments.

FIG. 3 is a flowchart illustrating aspects of a method for authenticating fingerprint data, according to some example embodiments.

FIG. 4 is a flowchart illustrating aspects of a method for receiving authentication of fingerprint data, according to some example embodiments.

FIG. 5 is a block diagram illustrating an example of a software architecture that may be installed on a machine, according to some example embodiments, configured for customized fingerprint authentication.

FIG. 6 is a diagrammatic representation of a machine, in the form of a computer system, within which a set of instructions may be executed for causing the machine to perform any one or more of the methodologies discussed herein, according to an example embodiment.

### DETAILED DESCRIPTION

Systems and methods described herein relate to customized fingerprint authentication. As mentioned above, there are many issues with conventional authentication for a user logging onto a system or conducting a payment transaction through a computing device (e.g., a mobile device). Conventional systems require many tedious steps such as a username, a password with varying requirements, a specific image, security questions, SMS or email confirmation, etc. Moreover, for increased security, many systems require a user regularly change his or her password, which requires yet more additional steps, and that a user keep track of multiple passwords for various systems, websites, applications, etc. And in payment transaction scenarios, a user also may provide a billing address, delivery address, method of payment, etc.

Fingerprint recognition technology is becoming more accessible. At the same time, users, companies, governments, etc. are looking for stronger identification confirmation systems to combat identity leakages and ensure security. Moreover, users desire more convenience for accessing a system or conducting a payment transaction. Embodiments described herein address such issues by providing for customized fingerprint authentication. For example, methods and systems described herein allow a user to be authenticated via fingerprint data and to link fingerprint data with various actions such as a payment method, delivery address, a device, a logon or sign on action, an unlock action, etc. Accordingly, embodiments described herein provide for more secure systems and methods and allow for improved user convenience.

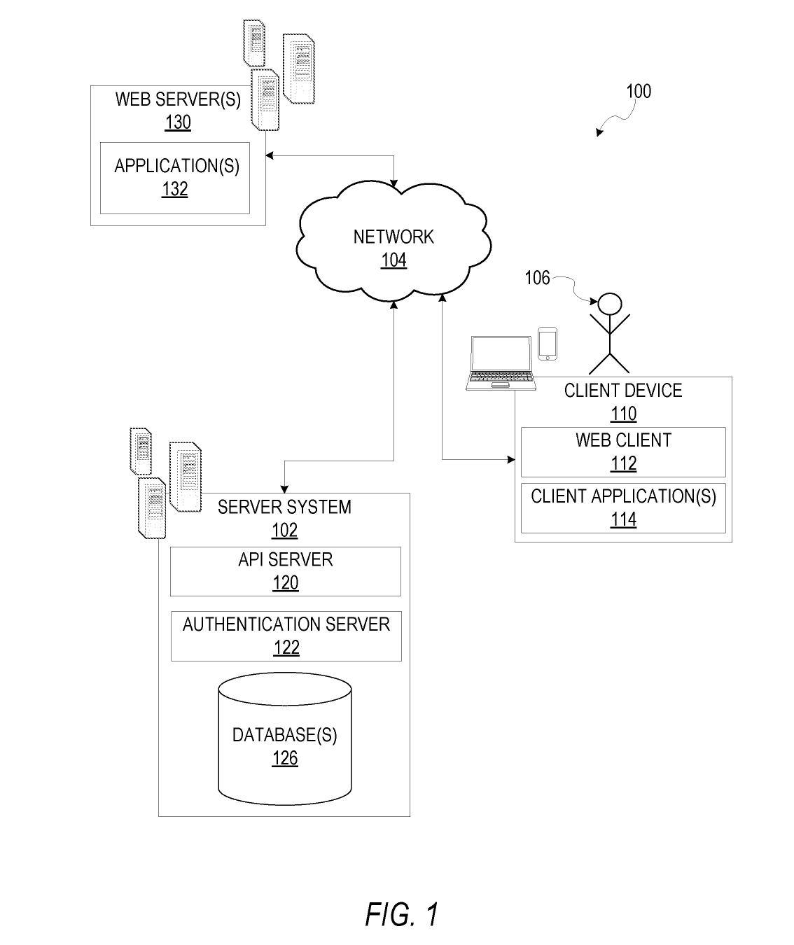

FIG. 1 is a block diagram illustrating a networked system 100, according to some example embodiments, configured for customized fingerprint authentication. The system 100 includes one or more client devices such as client device 110. The client device 110 may comprise, but is not limited to, a mobile phone, desktop computer, laptop, portable digital assistants (PDAs), smart phones, tablets, ultra books, netbooks, laptops, multi-processor systems, microprocessor-based or programmable consumer electronics, game consoles, set-top boxes, computers in vehicles, or any other communication device that a user may utilize to access the networked system 100. In some embodiments, the client device 110 comprises a display module (not shown) to display information (e.g., in the form of user interfaces). In further embodiments, the client device 110 comprises one or more of touch screens, accelerometers, gyroscopes, cameras, microphones, global positioning system (GPS) devices, and so forth.

In some embodiments the client device 110 comprises fingerprint capture technology in the form of hardware, software, or a combination of hardware or software. In other embodiments the client device 110 is coupled with a fingerprint capture device that comprises fingerprint capture technology in the form of hardware, software, or a combination of hardware or software. For example, fingerprint capture technology may comprise an electronic device (e.g., a sensor) to capture a digital image of a pattern or one or more fingerprints or handprints. That captured image may be a live scan that is digitally processed to create a biometric template (e.g., a collection of extracted features) that may be stored and used for matching fingerprints. In some embodiments, the captured image is converted into encrypted binary data to be transmitted and stored. For example, a user may press or hold/wave one or more fingers or palms on or near a display of a device or other fingerprint capture technology coupled with a device. The one or more fingerprints or handprints are captured by the fingerprint capture technology and sent to a server system (e.g., server system 102) to be stored, analyzed, etc.

There may be various fingerprint capture technologies that include various types of sensor technologies, such as optical, ultrasonic, capacitance (e.g., passive capacitance, active capacitance), etc. In some embodiments the fingerprint capture technology may capture one or more fingerprints from a user using one or more fingerprints to interact with the client device 110 or fingerprint capture technology coupled with the client device 110, for example, by contact (e.g., pressing one or more fingers on a display or designated area of the device), or by a contactless method (e.g., waving one or more fingers near a display or designated area of the device, or holding up one or more fingers near the display or designated area of the device, etc.).

The client device 110 may be a device of a user 106 that is used to search and display various information, such as information on the Internet via an application such as a web browser, shop for products or services, conduct a payment transaction, etc. In one embodiment, the system 100 is a customized fingerprint authentication system that allows a user 106 to register one or more fingerprints and conduct transactions (e.g., payment transactions) using the registered one or more fingerprints. A user 106 may use more than one device 110 or more than one type of device 110 to conduct a transaction, in some example embodiments. A user 106 may use more than one client applications 114 on the one or more client devices 110, in some example embodiments.

One or more users 106 may be a person, a machine, or other means of interacting with the client device 110. In example embodiments, the user 106 may not be part of the system 100, but may interact with the system 100 via the client device 110 or other means. For instance, the user 106 may provide input (e.g., touch screen input or alphanumeric input) to the client device 110 and the input may be communicated to other entities in the system 100 (e.g., web servers 130, server system 102, etc.) via the network 104. In this instance, the other entities in the system 100, in response to receiving the input from the user 106, may communicate information to the client device 110 via the network 104 to be presented to the user 106. In this way, the user 106 may interact with the various entities in the system 100 using the client device 110.

The system 100 further includes a network 104. One or more portions of network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

The client device 110 may access the various data and applications provided by other entities in the system 100 via a web client 112 (e.g., a browser, such as the INTERNET EXPLORER® browser developed by Microsoft® Corporation of Redmond, Wash. State) or one or more client applications 114. The client device 110 may include one or more applications 114 (also referred to as an “app” or “apps”) such as, but not limited to, a web browser, messaging application, electronic mail (email) application, an e-commerce site application, a mapping or location application, a news or media application, and the like. In some embodiments, one or more applications 114 are included in a given one of the client devices 110, and configured to locally provide the user interface and at least some of the functionalities, with the application 114 configured to communicate with other entities in the system 100 (e.g., web servers 130, server system 102, etc.), on an as needed basis, for data and/or processing capabilities not locally available (e.g., access to various information, to authenticate a user 106, to verify a method of payment, etc.). Conversely, one or more applications 114 may not be included in the client device 110, and then the client device 110 uses its web browser to access the one or more applications hosted on other entities in the system 100 (e.g., web servers 130, server system 102, etc.).

A server system 102 provides server-side functionality via the network 104 (e.g., the Internet or wide area network (WAN)) to one or more web servers 130 and/or one or more client devices 110. The server system 102 includes an application program interface (API) server 120 and an authentication server 122 that may be communicatively coupled with one or more database(s) 126. The database(s) 126 may be storage devices that store information such as information associated with users 106 of the system 100, fingerprint data, one or more actions associated with fingerprint data, information associated with client devices 110, etc.

The authentication server 122 provides functionality to receive fingerprint data, one or more actions associated with fingerprint data, user information, transaction information, etc., and to store such information in one or more database(s) 126. The authentication server 122 further provides functionality to receive requests to register fingerprint data, store and register fingerprint data, analyze fingerprint data, determine whether fingerprint data matches stored fingerprint data, determine one or more actions associated with fingerprint data, determine a unique device identifier associated with fingerprint data, send a response indicating that fingerprint data matches stored fingerprint data to other entities such as web server(s) 130 or client devices 110, etc. The authentication server 122 may access one or more database(s) 126 to retrieve stored data and to store such data. Fingerprint data may include data captured by fingerprint capture technology (e.g., from one or more of a user's fingers, hands, palms, etc.).

The system 100 further includes one or more web server(s) 130. The web server(s) 130 may be associated with a separate entity than the server system 102 (e.g., a third party) or may be associated with the same entity as server system 102. The one or more web servers 130 may include one or more application(s) 132 and one or more website(s) (e.g., websites hosted by web servers 130). The one or more application(s) 132, executing on web server(s) 130, may interact with the server system 102, for example, via API server 120 via a programmatic interface provided by the API server 120. The one or more websites may interact with the server system 102, for example, via API server 120 via a programmatic interface provided by API server 120. For example, one or more of the applications 132 and/or websites may request and utilize information from the server system 102 via the API server 120 to support one or more features or functions on a website hosted by the web server 130 or an application hosted by the web server 130. The website or application(s) 132, for example, may provide various functionality related to fingerprint authentication that are supported by relevant functionality and data in the server system 102. The web server(s) 130 may interact with one or more databases. The databases may be storage devices that store information such as information associated with fingerprints, users, applications, websites, etc. The application(s) 132 or websites may provide product and service information and conduct payment transactions related to products and services and may utilize authentication functionality and data in the server system 102. A client device 110 may access the web server(s) 130 using one or more applications 132, or one or more client applications 114, web client 112, etc.

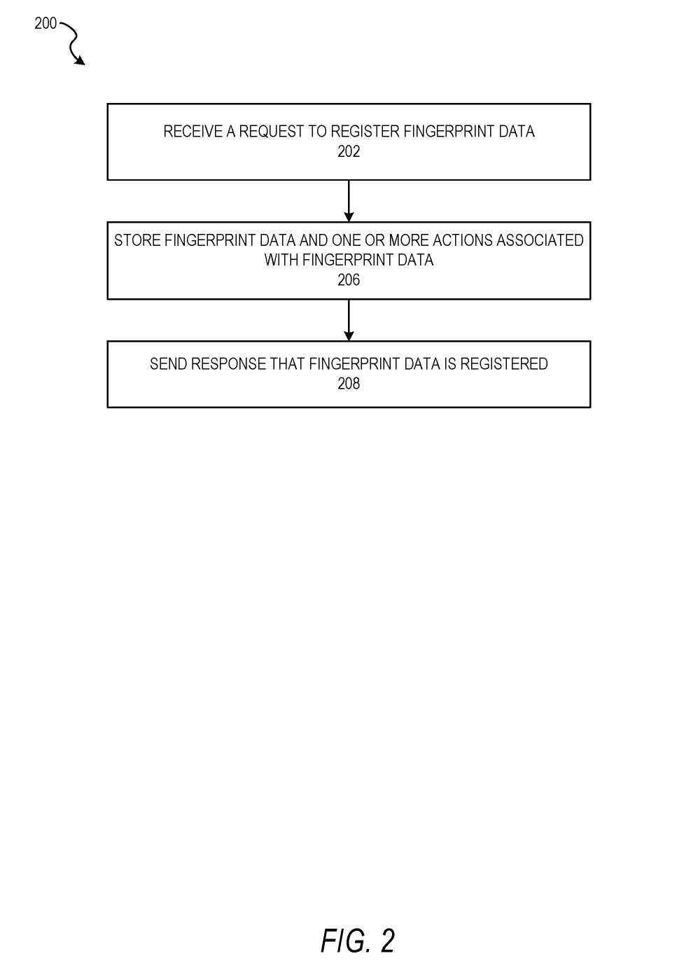

FIG. 2 is a flow chart illustrating aspects of a method 200 for registering fingerprint data, according to some example embodiments. For illustrative purposes, method 200 is described with respect to the networked system 100 of FIG. 1. It is to be understood that method 200 may be practiced with other system configurations in other embodiments.

In operation 202, the server system 102 (e.g., at authentication server 122 via API server 120) receives a request to register fingerprint data for a user. In one example embodiment the request is received from a client device 110 utilizing one or more client applications 114. In another example embodiment the request is received from a web server 130 to authenticate a user using an application 132 or 114 via a client device 110.

The request may be one of multiple (e.g., a plurality of) requests to register fingerprint data for multiple (e.g., a plurality of) users of the system 100. The request may include the fingerprint data, and additional information, such as one or more actions to be associated with the fingerprint data, a unique identifier associated with the client device 110, a user name, address, phone number, etc. The fingerprint data may include one or more fingerprints of a user (e.g., user 106), one or more palm or handprints of a user, or other biometric data for the user. The one or more actions to be associated with fingerprint data may include a payment method, a delivery address (e.g., for shipment of a product or service), a unique identifier associated with a device (e.g., a client device 110 serial number), a logon or sign on action, an unlock action, etc. A payment method may include a credit card, a debit card, a bank account, an electronic money method, etc. The payment method may further include an account number or identifier associated with the payment method (e.g., credit card identifier, bank account number, bank routing number, etc.).

For example, a user 106 may be shopping for a particular product or service utilizing a client application 114 or a web browser accessing one or more web server(s) 130 or applications 132. The user 106 may wish to conduct a payment transaction to purchase one or more products or services. The user 106 may want to register his or her fingerprint(s) so that he or she may utilize the fingerprint(s) for payment and/or other actions associated with a transaction or payment transaction on the account. The user 106 may be prompted to provide his fingerprints or palm prints. The user 106 may press his finger(s) on, or wave his fingers or hold his fingers in front of, the client device 110 or a device coupled to the client device 110. As described above, his fingerprint(s) may be captured using fingerprint capture technology. Fingerprint data captured by the fingerprint capture technology may be sent to the authentication server 122.

The user 106 may want to customize actions to be associated with the fingerprint data. For example, the user 106 may want to link his fingerprint data with a particular payment method and/or delivery address such that each time he uses his fingerprint for authentication in a payment transaction, the system will know to automatically apply the linked payment method and delivery address. The user 106 may be prompted to enter or select one or more actions such as a payment method and delivery address.

In one example embodiment, the fingerprint data may be encrypted binary data or the authentication server 122 may optionally convert the fingerprint data to encrypted binary data. In operation 206 the authentication server 122 stores the fingerprint data and any additional data (e.g., one or more actions associated with the fingerprint data, a unique identifier associated with the client device 110, etc.) in one or more databases 126.

In operation 208 the authentication server 122 sends a response indicating that the fingerprint data is registered. For example, the authentication server 122 may send the response to the client device 110, directly or via web server(s) 130. The client device 110 may receive the response and notify the user 106 that his or her fingerprint(s) have been registered.

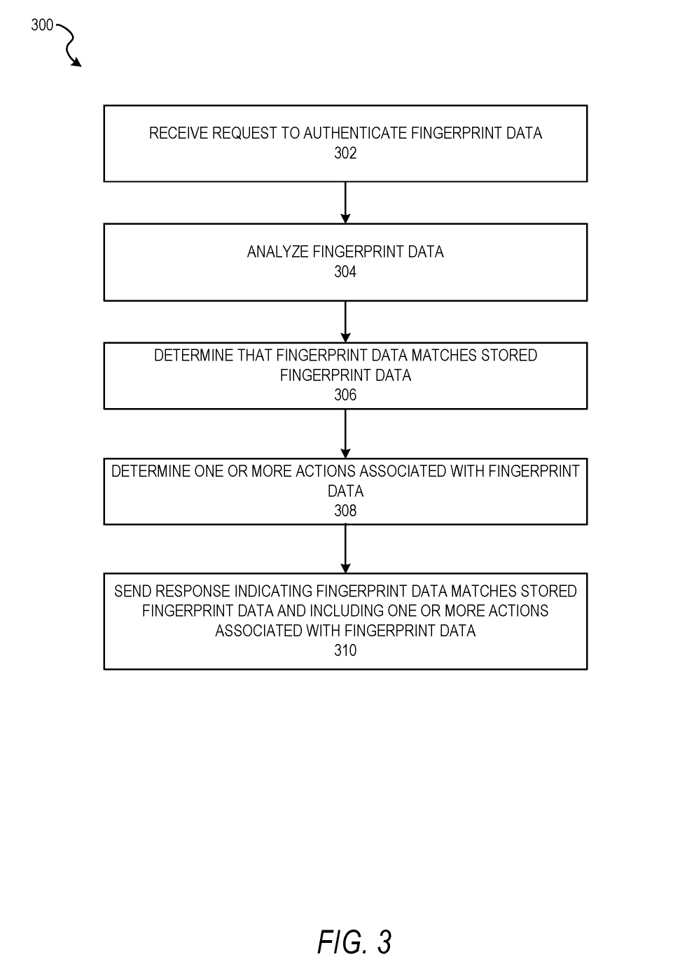

FIG. 3 is a flow chart illustrating aspects of a method 300 for authenticating fingerprint data, according to some example embodiments. For illustrative purposes, method 300 is described with respect to the networked system 100 of FIG. 1. It is to be understood that method 300 may be practiced with other system configurations in other embodiments.

In operation 302, the server system 102 (e.g., at authentication server 122 via API server 120) receives a request to authenticate fingerprint data (e.g., from a client device 110 directly or via web server 130). The request to authenticate fingerprint data may include the fingerprint data. The request to authenticate fingerprint data may optionally include additional information such as a unique device identifier associated the client device 110.

For example, a user 106 may be using an application 114 or 132 or a website via web client 112, etc. to make a payment transaction (e.g., purchase clothing via a clothing company website). The user 106 may have already registered his fingerprint data with the server system 102. The user 106 may be prompted to press or hold/wave one or more fingers, palms, etc. on a display or other fingerprint capture mechanism. Once the user 106 has done so, the application sends a request to authenticate the fingerprint data (e.g., via client device 110 or web server 130) to the server system 102.

At operation 304, the authentication server 122 analyses the fingerprint data. For example, the authentication server 122 may determine whether the fingerprint data matches stored fingerprint data by comparing the fingerprint data to fingerprint data stored in one or more databases 126. Optionally, the authentication server 122 may convert the fingerprint data to binary data before analyzing the fingerprint data to determine whether it matches stored fingerprint data (e.g., by comparing binary data for the fingerprint data to binary data of stored fingerprint data). If it does not match stored fingerprint data, it may return a response to the web server 130 or client device 110 indicating that the fingerprint data does not match stored data. The web server 130 or client device 110 may cause a message to be displayed to the user 106 that his fingerprint data does not match, and/or prompt the user 106 to register his fingerprint data, etc.

At operation 306, the authentication server 122 determines that the fingerprint data matches stored fingerprint data.

In one embodiment, the request to authenticate may include a unique identifier associated with the client device 110. The authentication server 122 may determine whether the unique identifier associated with the client device 110 matches a unique identifier associated with the stored fingerprint data. For example, the user 106 may have specified (e.g., during registration of fingerprint data) that he only wants fingerprint authentication to be valid on a particular client device. In one example, the fingerprint data may be for a child of the user 106 and the user may only want the child to be able to make purchases (for example) on a particular device. In another example, the user 106 may only want the child to be able to access certain websites on a certain device (e.g., a personal device versus a work device), and thus, the fingerprint data for the child will only be valid if it is coming from the certain device or accessing a certain website or application (e.g., the child is allowed to purchase kid-friendly apps from a kid-friendly website but not purchase goods or services from other websites). Thus, the system 102 may also store information associated with a particular application, system, website, etc.

At operation 308, the authentication server 122 determines one or more actions associated with the fingerprint data. For example, the authentication server 122 may look up any associated actions in one or more databases 126. At operation 310 the authentication server 122 sends a response indicating that the fingerprint data matches stored fingerprint data and include the one or more actions associated with the fingerprint data. In one embodiment the response may further include an indication that the unique identifier received in the request for authentication of the fingerprint data matches (or does not match) the unique identifier associated with the stored matching fingerprint data.

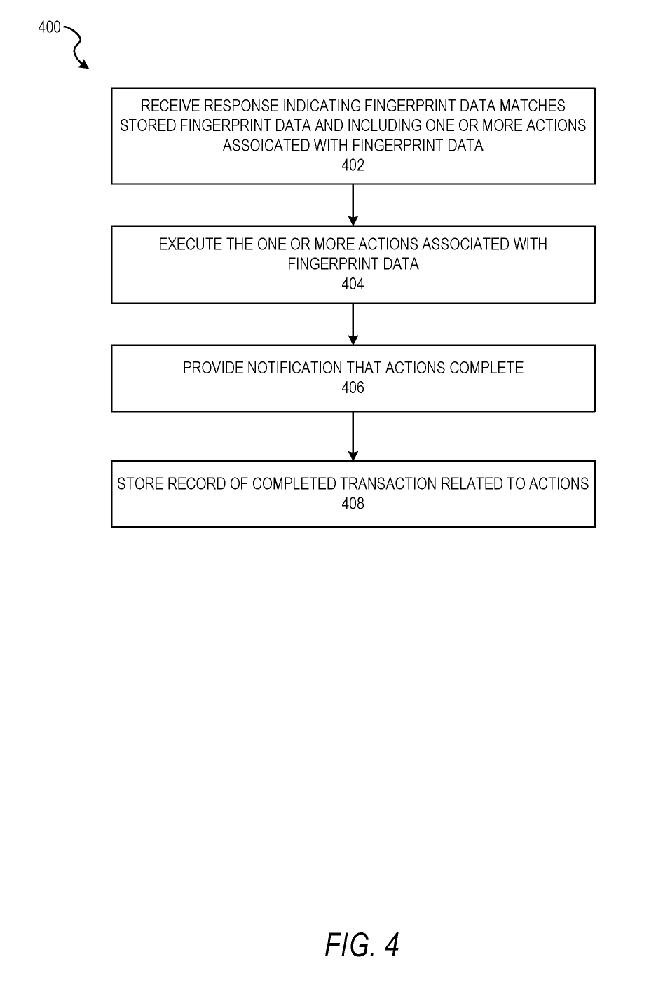

FIG. 4 is a flow chart illustrating aspects of a method 400 for receiving authentication of fingerprint data, according to some example embodiments. For illustrative purposes, method 400 is described with respect to the networked system 100 of FIG. 1. It is to be understood that method 400 may be practiced with other system configurations in other embodiments.

At operation 402, the client device 110 (e.g., directly or via web server 130) receives a response indicating that the fingerprint data has been authenticated (e.g., fingerprint data matches stored fingerprint data) and including one or more actions associated with the fingerprint data. At operation 404 the client device 110 executes the one or more actions associated with the fingerprint data. For example, the one or more actions may include a payment method and delivery address, and the client device 110 may cause a payment transaction to occur using the payment method and delivery address.

At operation 406, the client device 110 provides notification to the user 106 that the actions are complete and cause a record of the completed transaction to be stored, at operation 408.

Examples used herein relate to purchase and payment transactions. It is understood that embodiments described herein may be used for other authentication scenarios such as logging onto a website, application, or system (e.g., instead of a username, password, etc.), unlocking a device or screen (e.g., instead of a PIN or password, etc. to access a device or unlock a screen on a device), etc.

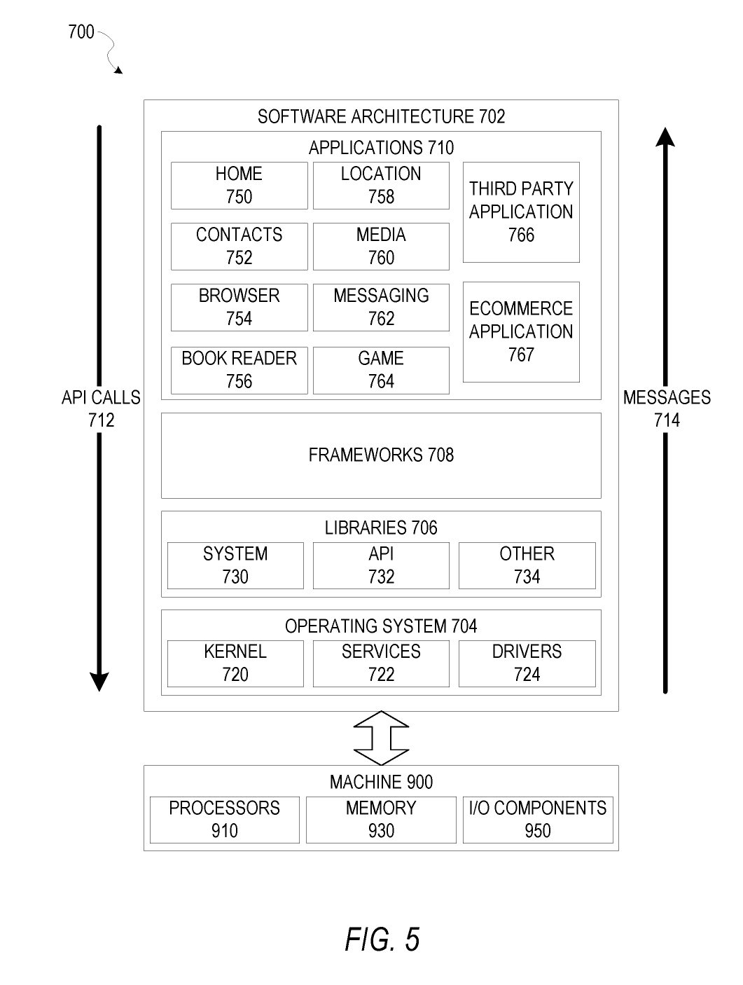

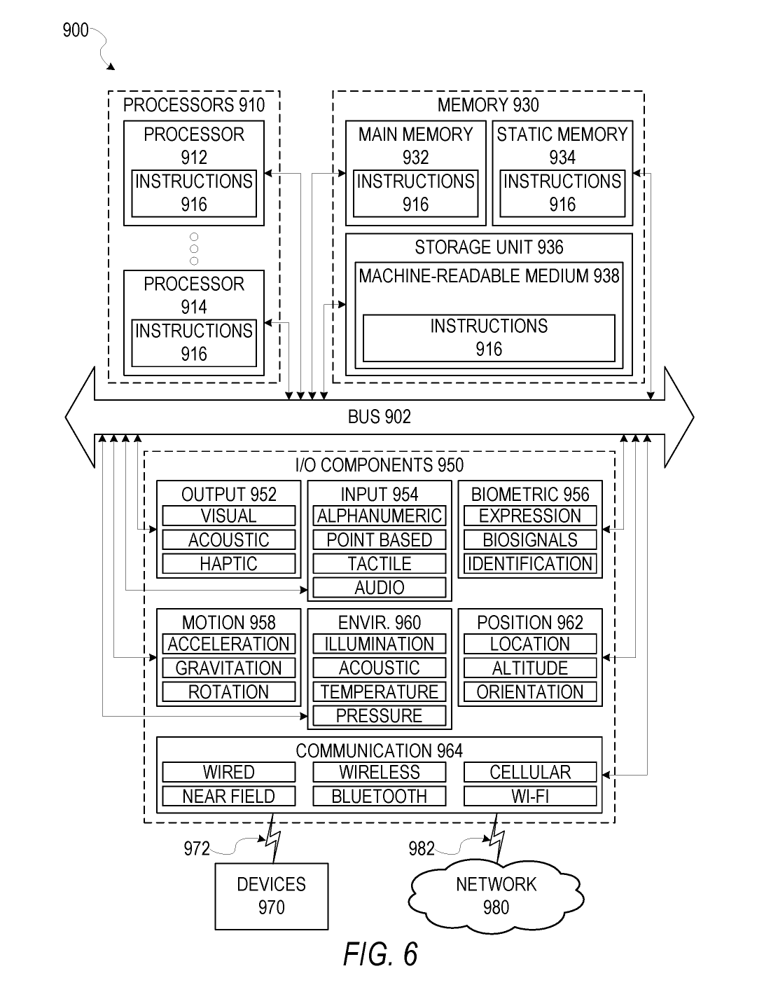

FIG. 5 is a block diagram 700 illustrating a software architecture 702, which can be installed on any one or more of the devices described above. For example, in various embodiments, client devices 110 and server system 102, and servers 102, 122, and 130, may be implemented using some or all of the elements of software architecture 702. FIG. 5 is merely a non-limiting example of a software architecture, and it will be appreciated that many other architectures can be implemented to facilitate the functionality described herein. In various embodiments, the software architecture 702 is implemented by hardware such as machine 900 of FIG. 6 that includes processors 910, memory 930, and I/O components 950. In this example, the software architecture 702 can be conceptualized as a stack of layers where each layer may provide a particular functionality. For example, the software architecture 702 includes layers such as an operating system 704, libraries 706, frameworks 708, and applications 710. Operationally, the applications 710 invoke application programming interface (API) calls 712 through the software stack and receive messages 714 in response to the API calls 712, consistent with some embodiments.

In various implementations, the operating system 704 manages hardware resources and provides common services. The operating system 704 includes, for example, a kernel 720, services 722, and drivers 724. The kernel 720 acts as an abstraction layer between the hardware and the other software layers, consistent with some embodiments. For example, the kernel 720 provides memory management, processor management (e.g., scheduling), component management, networking, and security settings, among other functionality. The services 722 can provide other common services for the other software layers. The drivers 724 are responsible for controlling or interfacing with the underlying hardware, according to some embodiments. For instance, the drivers 724 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

In some embodiments, the libraries 706 provide a low-level common infrastructure utilized by the applications 710. The libraries 706 can include system libraries 730 (e.g., C standard library) that can provide functions such as memory allocation functions, string manipulation functions, mathematic functions, and the like. In addition, the libraries 706 can include API libraries 732 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in graphic content on a display), database libraries (e.g., SQLite to provide various relational database functions), web libraries (e.g., WebKit to provide web browsing functionality), and the like. The libraries 706 can also include a wide variety of other libraries 734 to provide many other APIs to the applications 710.

The frameworks 708 provide a high-level common infrastructure that can be utilized by the applications 710, according to some embodiments. For example, the frameworks 708 provide various graphic user interface (GUI) functions, high-level resource management, high-level location services, and so forth. The frameworks 708 can provide a broad spectrum of other APIs that can be utilized by the applications 710, some of which may be specific to a particular operating system 704 or platform.

In an example embodiment, the applications 710 include a home application 750, a contacts application 752, a browser application 754, a book reader application 756, a location application 758, a media application 760, a messaging application 762, a game application 764, an ecommerce application 767, and a broad assortment of other applications such as a third party applications 766. According to some embodiments, the applications 710 are programs that execute functions defined in the programs. Various programming languages can be employed to create one or more of the applications 710, structured in a variety of manners, such as object-oriented programming languages (e.g., Objective-C, Java, or C++) or procedural programming languages (e.g., C or assembly language). In a specific example, the third party application 766 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third party application 766 can invoke the API calls 712 provided by the operating system 704 to facilitate functionality described herein.

Some embodiments may include an ecommerce application 767. In certain embodiments, this may be a stand-alone application that operates to manage communications with a server system such as server system 102 or web server(s) 130. In other embodiments, this functionality may be integrated with another application. Ecommerce application 767 may provide the capability for a user, such as user 106, to shop for and purchase various goods and services via a touch interface, keyboard, or using a camera device of machine 900, communication with a server system via I/O components 950, and receipt and storage of job configuration data in memory 930. Presentation of ecommerce information and user inputs associated with ecommerce information may be managed by ecommerce application 767 using different frameworks 708, library 706 elements, or operating system 704 elements operating on a machine 900.

FIG. 6 is a block diagram illustrating components of a machine 900, according to some embodiments, able to read instructions from a machine-readable medium (e.g., a machine-readable storage medium) and perform any one or more of the methodologies discussed herein. Specifically, FIG. 6 shows a diagrammatic representation of the machine 900 in the example form of a computer system, within which instructions 916 (e.g., software, a program, an application 710, an applet, an app, or other executable code) for causing the machine 900 to perform any one or more of the methodologies discussed herein can be executed. In alternative embodiments, the machine 900 operates as a standalone device or can be coupled (e.g., networked) to other machines. In a networked deployment, the machine 900 may operate in the capacity of a server in server system 102, servers 120, 122, 130, etc., or a client device 110 in a server-client network environment, or as a peer machine in a peer-to-peer (or distributed) network environment. The machine 900 can comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 916, sequentially or otherwise, that specify actions to be taken by the machine 900. Further, while only a single machine 900 is illustrated, the term “machine” shall also be taken to include a collection of machines 900 that individually or jointly execute the instructions 916 to perform any one or more of the methodologies discussed herein.

In various embodiments, the machine 900 comprises processors 910, memory 930, and I/O components 950, which can be configured to communicate with each other via a bus 902. In an example embodiment, the processors 910 (e.g., a central processing unit (CPU), a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor, or any suitable combination thereof) include, for example, a processor 912 and a processor 914 that may execute the instructions 916. The term “processor” is intended to include multi-core processors 910 that may comprise two or more independent processors 912, 914 (also referred to as “cores”) that can execute instructions 916 contemporaneously. Although FIG. 6 shows multiple processors 910, the machine 900 may include a single processor 910 with a single core, a single processor 910 with multiple cores (e.g., a multi-core processor 910), multiple processors 912, 914 with a single core, multiple processors 910, 912 with multiples cores, or any combination thereof.

The memory 930 comprises a main memory 932, a static memory 934, and a storage unit 936 accessible to the processors 910 via the bus 902, according to some embodiments. The storage unit 936 can include a machine-readable medium 938 on which are stored the instructions 916 embodying any one or more of the methodologies or functions described herein. The instructions 916 can also reside, completely or at least partially, within the main memory 932, within the static memory 934, within at least one of the processors 910 (e.g., within the processor's cache memory), or any suitable combination thereof, during execution thereof by the machine 900. Accordingly, in various embodiments, the main memory 932, the static memory 934, and the processors 910 are considered machine-readable media 938.

As used herein, the term “memory” refers to a machine-readable medium 938 able to store data temporarily or permanently and may be taken to include, but not be limited to, random-access memory (RAM), read-only memory (ROM), buffer memory, flash memory, and cache memory. While the machine-readable medium 938 is shown, in an example embodiment, to be a single medium, the term “machine-readable medium” should be taken to include a single medium or multiple media (e.g., a centralized or distributed database, or associated caches and servers) able to store the instructions 916. The term “machine-readable medium” shall also be taken to include any medium, or combination of multiple media, that is capable of storing instructions (e.g., instructions 916) for execution by a machine (e.g., machine 900), such that the instructions 916, when executed by one or more processors of the machine 900 (e.g., processors 910), cause the machine 900 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., erasable programmable read-only memory (EPROM)), or any suitable combination thereof. The term “machine-readable medium” specifically excludes non-statutory signals per se.

The I/O components 950 include a wide variety of components to receive input, provide output, produce output, transmit information, exchange information, capture measurements, and so on. In general, it will be appreciated that the I/O components 950 can include many other components that are not shown in FIG. 9. The I/O components 950 are grouped according to functionality merely for simplifying the following discussion, and the grouping is in no way limiting. In various example embodiments, the I/O components 950 include output components 952 and input components 954. The output components 952 include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 954 include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

In some further example embodiments, the I/O components 950 include biometric components 956, motion components 958, environmental components 960, or position components 962, among a wide array of other components. For example, the biometric components 956 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 958 include acceleration sensor components (e.g., accelerometer), gravitation sensor components, rotation sensor components (e.g., gyroscope), and so forth. The environmental components 960 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensor components (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 962 include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication can be implemented using a wide variety of technologies. The I/O components 950 may include communication components 964 operable to couple the machine 900 to a network 980 or devices 970 via a coupling 982 and a coupling 972, respectively. For example, the communication components 964 include a network interface component or another suitable device to interface with the network 980. In further examples, communication components 964 include wired communication components, wireless communication components, cellular communication components, near field communication (NFC) components, BLUETOOTH® components (e.g., BLUETOOTH® Low Energy), WI-FI® components, and other communication components to provide communication via other modalities. The devices 970 may be another machine 900 or any of a wide variety of peripheral devices (e.g., a peripheral device coupled via a Universal Serial Bus (USB)).

Moreover, in some embodiments, the communication components 964 detect identifiers or include components operable to detect identifiers. For example, the communication components 964 include radio frequency identification (RFID) tag reader components, NFC smart tag detection components, optical reader components (e.g., an optical sensor to detect a one-dimensional bar codes such as a Universal Product Code (UPC) bar code, multi-dimensional bar codes such as a Quick Response (QR) code, Aztec Code, Data Matrix, Dataglyph, MaxiCode, PDF417, Ultra Code, Uniform Commercial Code Reduced Space Symbology (UCC RSS)-2D bar codes, and other optical codes), acoustic detection components (e.g., microphones to identify tagged audio signals), or any suitable combination thereof. In addition, a variety of information can be derived via the communication components 964, such as location via Internet Protocol (IP) geo-location, location via WI-FI® signal triangulation, location via detecting a BLUETOOTH® or NFC beacon signal that may indicate a particular location, and so forth.

In various example embodiments, one or more portions of the network 980 can be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the public switched telephone network (PSTN), a plain old telephone service (POTS) network, a cellular telephone network, a wireless network, a WI-FI® network, another type of network, or a combination of two or more such networks. For example, the network 980 or a portion of the network 980 may include a wireless or cellular network, and the coupling 982 may be a Code Division Multiple Access (CDMA) connection, a Global System for Mobile communications (GSM) connection, or another type of cellular or wireless coupling. In this example, the coupling 982 can implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

In example embodiments, the instructions 916 are transmitted or received over the network 980 using a transmission medium via a network interface device (e.g., a network interface component included in the communication components 964) and utilizing any one of a number of well-known transfer protocols (e.g., Hypertext Transfer Protocol (HTTP)). Similarly, in other example embodiments, the instructions 916 are transmitted or received using a transmission medium via the coupling 972 (e.g., a peer-to-peer coupling) to the devices 970. The term “transmission medium” shall be taken to include any intangible medium that is capable of storing, encoding, or carrying the instructions 916 for execution by the machine 900, and includes digital or analog communications signals or other intangible media to facilitate communication of such software.

Furthermore, the machine-readable medium 938 is non-transitory (in other words, not having any transitory signals) in that it does not embody a propagating signal. However, labeling the machine-readable medium 938 “non-transitory” should not be construed to mean that the medium is incapable of movement; the medium 938 should be considered as being transportable from one physical location to another. Additionally, since the machine-readable medium 938 is tangible, the medium 938 may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
receiving, at a server computer, a request to register a first fingerprint data, the request including the first fingerprint data and an action to be associated with the first fingerprint data;
storing, by the server computer, the first fingerprint data and the action associated with the first fingerprint data;
receiving, by the server computer, a request for authentication of a second fingerprint data;
analyzing, by the server computer, the second fingerprint data to determine whether it matches stored fingerprint data;
determining, by the server computer, that the second fingerprint data matches the stored first fingerprint data;
determining, by the server computer, the action associated with the first fingerprint data; and
sending, by the server computer, a response indicating that the second fingerprint data matches the stored fingerprint data and including the action associated with the first fingerprint data.

2. The method of claim 1, wherein the request to register a first fingerprint data is received from a first client device, and wherein the request to register the first fingerprint data further includes a unique identifier associated with the first client device, and the method further comprising:
associating the unique identifier associated with the first client device, with the first fingerprint data and the action associated with the first fingerprint data; and
storing the unique identifier associated with the first client device.

3. The method of claim 2, wherein the request for authentication of the second fingerprint data is received from a second client device, and wherein the request for authentication of the second fingerprint data further includes a unique identifier associated with the second client device, and wherein after determining that the second fingerprint data matches the stored first fingerprint data, the method further comprising:
determining whether the unique identifier associated with the first device matches the unique identifier associated with the second device.

4. The method of claim 3, wherein the response further includes an indication that the unique identifier associated with the first device matches the unique identifier associated with the second device.

5. The method of claim 1, wherein the first fingerprint data includes data associated with one or more fingerprints of a user or one or more handprints of a user.

6. The method of claim 1, wherein the action includes at least one of a group comprising: a payment method, a delivery address, a unique identifier associated with a device, a logon or sign on action, and an unlock action.

7. The method of claim 6, wherein the payment method includes a credit card, a debit card, a bank account, or an electronic money method.

8. The method of claim 1, wherein the first fingerprint data is converted to binary data before storing the first fingerprint data.

9. The method of claim 8, wherein the second fingerprint data is converted to binary data before analyzing the second fingerprint data to determine whether it matches stored fingerprint data.

10. The method of claim 9, wherein analyzing the second fingerprint data to determine whether it matches stored fingerprint data includes comparing binary data for the second fingerprint data against binary data for the first fingerprint data.

11. The method of claim 1, further comprising:
sending a response indicating that the first fingerprint data is registered.

12. A server computer comprising:
one or more processors; and
a computer readable medium coupled with the one or more processors, the computer readable medium comprising instructions stored thereon that are executable by the one or more processors to cause a computing device to:
receive a request to register a first fingerprint data, the request including the first fingerprint data and an action to be associated with the first fingerprint data;
store the first fingerprint data and the action associated with the first fingerprint data;
receive a request for authentication of a second fingerprint data;
analyze the second fingerprint data to determine whether it matches stored fingerprint data;
determine that the second fingerprint data matches the stored first fingerprint data;
determine the action associated with the first fingerprint data; and
send a response indicating that the second fingerprint data matches the stored fingerprint data and including the action associated with the first fingerprint data.

13. The server computer of claim 12, wherein the first fingerprint data includes data associated with one or more fingerprints of a user or one or more handprints of a user.

14. The server computer of claim 12, wherein the action includes at least one of a group comprising: a payment method, a delivery address, a unique identifier associated with a device, a logon or sign on action, and an unlock action.

15. The server computer of claim 14, wherein the payment method includes a credit card, a debit card, a bank account, or an electronic money method.

16. The server computer of claim 12, wherein the first fingerprint data is converted to binary data before storing the first fingerprint data.

17. The server computer of claim 16, wherein the second fingerprint data is converted to binary data before analyzing the second fingerprint data to determine whether it matches stored fingerprint data.

18. The server computer of claim 17, wherein analyzing the second fingerprint data to determine whether it matches stored fingerprint data includes comparing binary data for the second fingerprint data against binary data for the first fingerprint data.

19. The server computer of claim 12, wherein the instructions that are executable by the one or more processors further cause the computing device to:
send a response indicating that the first fingerprint data is registered.

20. A non-transitory computer readable medium comprising instructions stored thereon that are executable by one or more processors to cause a computing device to:
receive a request to register a first fingerprint data, the request including the first fingerprint data and an action to be associated with the first fingerprint data;
store the first fingerprint data and the action associated with the first fingerprint data;
receive a request for authentication of a second fingerprint data;
analyze the second fingerprint data to determine whether it matches stored fingerprint data;
determine that the second fingerprint data matches the stored first fingerprint data;
determine the action associated with the first fingerprint data; and
send a response indicating that the second fingerprint data matches the stored fingerprint data and including the action associated with the first fingerprint data.
